(19) United States
(12) Patent Application Publication
(10) Pub. No.: US 2015/0166813 A1
(43) Pub. Date: Jun. 18, 2015

(54) SPRAYABLE COMPOSITION FOR STABILISING BROKEN GLASS AND METHOD OF APPLYING SAME

(71) Applicant: AIE FINSOL PTY LIMITED, West Wollongong (AU)

(72) Inventors: William John NOBLE, West Wollongong (AU); John Phillip Scott, West Wollongong (AU); Loay Ghalib, West Wollongong (AU)

(21) Appl. No.: 14/575,459

(22) Filed: Dec. 18, 2014

(30) Foreign Application Priority Data
Dec. 18, 2013 (AU) 2013 904 939

(51) Int. Cl. C09D 133/00; B65D 83/14; C03C 17/32; C08K 5/521; C03C 17/00

(52) U.S. Cl. CPC C09D 133/00; C08K 5/521; C03C 17/002; C03C 17/324; B65D 83/752; C03C 2217/29; C03C 2217/78; C03C 2218/112; C03C 2218/328; C03C 2218/32; C03C 2218/355

(57) ABSTRACT

A sprayable glass stabilising composition includes an acrylic polymer emulsion in the amount of 40%-65%; an acrylic binder in the amount of 16.8%-31.4%; an acrylic polymer emulsion thickener in the amount of 0.32%-0.62%; an ester surfactant in the amount of 0.32%-0.62%; a foam control agent in the amount of 0.32%-0.62%; and water or alcohol, or a mixture thereof, in the amount of 7%-15%.

### FIELD OF THE INVENTION

The present invention relates to a sprayable composition that forms a protective film to glass that has been broken or fractured or is at risk of such.

The invention has been developed primarily for use in safely removing broken glass panes or remnants thereof and will be described hereinafter with reference to this application. However, it will be appreciated that the invention is not limited to this particular field of use and is applicable to glass in expectation or anticipation of damage or fracture and need for subsequent removal and/or replacement.

### BACKGROUND OF THE INVENTION

Glass window and door panes, and including window and door structures substantially or wholly formed from glass, are ubiquitous and come in a range of different sizes, thicknesses, compositions and types. Most commonly, glass panes have been ‘float glass’ which is made by floating glass ingredients on a molten bed.

Float glass is typically 2-12 mm thick and was, until relatively recently, the choice for most windows and doors, particularly in homes. Many premises still have float glass panes and often a significant number. Unfortunately, this glass is dangerous when it is fractured or broken as it breaks into sharp shards or splinters. This is a dangerous situation and includes, for example, where a person breaks a float glass pane, damage is often done by the sharp broken edges that are created. Broken float glass panes require thorough removal to ensure all broken glass is removed, especially where children are likely to dwell such as in homes or public areas.

Toughened glass has in the past been a single pane whereas laminated glass is typically two or more panes attached together. Typically, toughened glass is between 3-12 mm and above thick. Laminated glass panes are somewhat larger, typically being between about 5.38-16 mm and above thick. Toughened glass panes are designed, when broken or fractured, to crumble into small pieces that have sharp edges. These small pieces typically pose a hazard to handling and of course have the obvious danger that small pieces may not be entirely removed. It should be noted that float glass will generally crack, break to large pieces as well as shards whereas toughened will crack and break to small pieces.

Toughened glass is intended to shatter and has a tendency to collapse when fractured or broken. Laminated panes often are not intended to shatter and only to retain fragments to the extent some strength remains from the remnants of the fractured glass pane. When laminated glass panes are broken or fractured, irregular sharp shards and fragments are created. Laminated glass is made up of two (or more) sheets of float glass joined together and if only one surface of the laminated glass has broken or fractured the laminated glass will remain as one, but if both surfaces have been broken or fractured, the glass pane will become unstable. It will be understood that in either the case of toughened or laminated glass panes, remaining parts of a fractured or broken glass pane are fragile to being handled.

Regardless of the type of glass pane or whether it is a glass object or contains glass such as a door, it is typical to simply remove a fractured or broken pane by literally knocking it out of its frame or support. This is obviously messy and relatively dangerous and far from ideal in many circumstances. For example, window or glass balustrades in multi-level buildings cannot simply be knocked out or allow any glass to fall outwardly away from the building in the process. However, toughened or laminated (both glass panes) glass panes that are broken or fractured, or parts of them, may fall on their own accord, even in a relatively gentle breeze or such as by the closing/opening of an internal door changing air pressure about the fractured window.

Any handling of the fractured or broken glass is most undesirable for the obvious reasons. Once the glass is removed, it is usually the case that fragments of the broken glass are found in the framing of windows or tracks of sliding doors or about the general location of the glass when fractured.

It is known to apply a tape or adhesive sheet to one or both sides of the remnants of a fractured or broken window pane, for example. However, this inherently can disturb the pane causing the fractured pane or any fragile remnants to fall. Notwithstanding, it is difficult to apply a tape or adhesive sheet in many circumstances due to the fragility of what remains, noting the difficulties in reaching the outside of the window or balustrade on multilevel buildings.

Of recent times, a method of removing broken or fractured window pane was developed. This is described in U.S. Pat. No. 7,231,747 (the 747' patent). In this patent, a two part foam is mixed at application by a spraying device and applied to remnants of a broken window. Once sprayed, the separated contents immediately mix and react creating the foam which expands and solidifies forming a unitary mass. The entire foam unitary mass enveloping the remnants of the broken glass pane are then removed.

This has shown to be a somewhat useful invention for its intended use of replacing the need to board external windows and glass doors and to a lesser degree those with fractured float glass. However, it is severely lacking for use with other glasses, particularly those that are especially fragile once fractured or broken or where the remnants are above ground level.

The method of the 747' patent requires that the entire window frame and surrounding areas be securely taped off before the foam is applied to the broken pane. As the foam is applied and expands, significant weight is added to the broken glass pane. The mere application of the foam to broken toughened glass can in itself cause the remnants to collapse. Further, applying a masking layer will often do likewise and create risks from falling glass fragments.

Furthermore, the 747' patent also requires that once the foam has solidified, boards and later handles are required to remove the foam containing the broken glass. Obviously, this is most undesirable in multi-level buildings. This is emphasised by the 747' patent in that plywood or other pre-formed panels can be used to impart stability on a destabilised glass window pane. This can assist in holding the remnants in place until the foam solidifies, however, applying the plywood is not possible from the outside of a multi-level building on many occasions and its mere placement would cause destabilisation. Most undesirably, the expanded foam mass can easily damage most types of window frame such as powder coated aluminium or painted timber, and possibly surrounding material if not exactly taped off or if accidentally sprayed onto.

In addition to the 747' patent, other sprayable foaming protective compositions are known and are commercially available. Foaming glass protective methods however exhibit some tendency to cling to a surface when sprayed thereon and to dwell on the surface for a long period of time. Foams often contain at least 15 to 30 percent air, which is known to result in incomplete product to surface contact during dwell time, thus also reducing convenience.

### GENESIS OF THE INVENTION

The genesis of the present invention is a desire to provide a composition which can be sprayed on to broken window panes forming a film to stabilise them for their removal and which overcomes the disadvantages of the prior art, or to provide a useful alternative.

### SUMMARY OF THE INVENTION

According to a first aspect of the invention there is provided a sprayable glass stabilising composition comprising:
an acrylic polymer emulsion in the amount of 40%-65%;
an acrylic binder in the amount of 16.8%-31.4%;
an acrylic polymer emulsion thickener in the amount of 0.32%-0.62%;
an ester surfactant in the amount of 0.32%-0.62%;
a foam control agent in the amount of 0.32%-0.62%; and
water in the amount of 7%-15%.

According to a second aspect of the invention there is provided a sprayable glass stabilising composition comprising:
an acrylic polymer emulsion of Elastene 2438 manufactured by the Dow Chemical Company in the amount of 52.6%-67.1%;
an acrylic binder of Primal AC-3001 manufactured by the Dow Chemical Company in the amount of 23.5%-31.8%;
an acrylic polymer emulsion thickener of Acrysol TT615 manufactured by the Dow Chemical Company in the amount of 0.45%-0.61%;
an ester surfactant of STRODEX TH-100 manufactured by Ashland, Inc in the amount of 0.45%-0.61%;
a foam control agent of DREWPLUS T4507 manufactured by Ashland, Inc in the amount of 0.45%-0.61%; and
water in the amount of 7.5%-10.2%.

According to a third aspect of the invention there is provided a method of stabilising a glass pane, the method comprising the step of spraying the composition of the first or second aspects of the invention as liquid or aerosolised liquid on to one or both faces of the glass pane and allowing same to cure and form a film on said glass.

According to a fourth aspect of the invention there is provided a method of removing a fractured or broken glass pane from a frame or retaining fitting, the method comprising the steps of:
spraying the composition of the first or second aspect of the invention as a liquid or aerosolised liquid onto at least one face of the remnants of the fractured or broken glass pane;
waiting a predetermined period of time for the sprayed composition to cure and form a film on said glass;
applying a predetermined force to the glass pane and removing the fractured or broken glass pane remnants attached to said cured composition; and
peeling any cured composition from about the pane frame.

According to another aspect of the invention there is provided a sprayable glass stabilising composition system comprising:
a container adapted to hold a pressurised predetermined volume of the composition according to the first or second aspect of the invention or a predetermined volume of the composition such that the container is adapted to be pressurised by a pressurising fluid;
an actuator connected to an outlet of the container and configured to be operated to selectively release the composition under pressure.

It can therefore be seen there is advantageously provided a sprayable glass stabilising composition having a relatively negligible mass that can be applied to one face of a broken or fractured glass pane to stabilise it and allow it to be removed. Most advantageously, no masking about or other interference of the broken or fractured pane is required in order to apply the composition and stabilise the glass pane, and it can be sprayed on by any lay person or professional alike. Furthermore, the composition is suited for use is stabilising broken glass panes on multilevel buildings eliminating any need for external access to the broken glass pane.

### DESCRIPTION OF THE DRAWINGS

A preferred embodiment of the composition of the invention will now be described, by way of example only, with reference to the accompanying drawings and following non-limiting example in which:

FIG. 1 is a schematic elevated perspective view of a window pane having been sprayed with a sprayable glass composition according to the preferred embodiment;

FIG. 2 is a schematic elevated perspective view of the removal of the frame at the window pane of FIG. 1;

FIG. 3 is a schematic elevated perspective view of the window pane of FIG. 1 being removed;

FIG. 4 is a schematic cut-away side view of an aerosol can having the composition according to the preferred embodiment therein for selectively dispensing; and

FIG. 5 is a pneumatic spray gun as an alternative dispenser to that of FIG. 4.

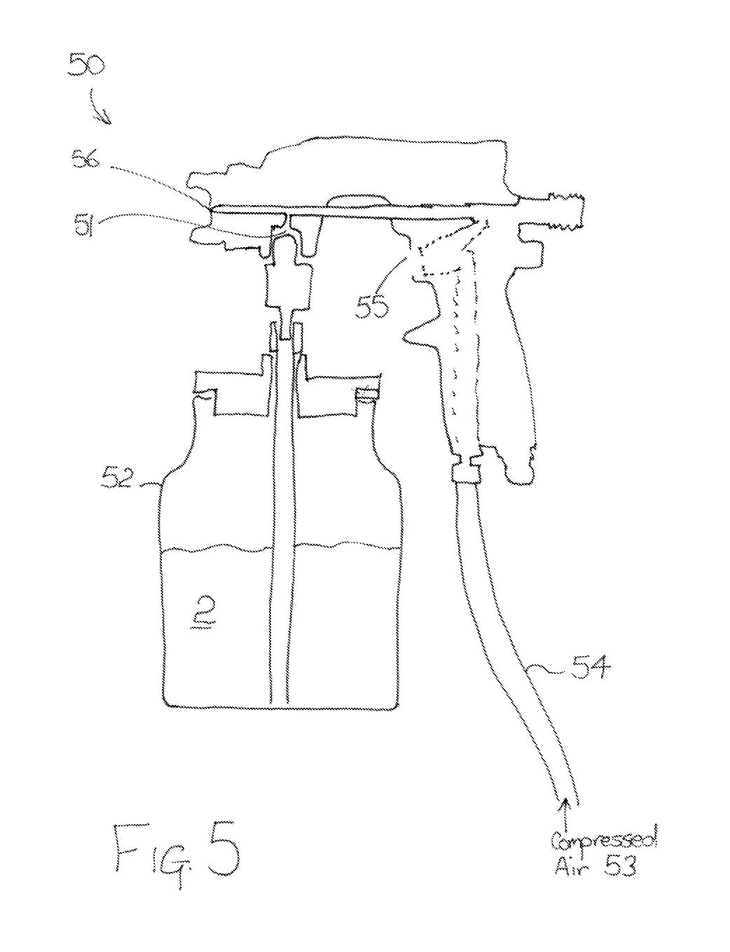

### DETAILED DESCRIPTION

The term “glass” as used herein is intended to include various types of glass including treated glass, untreated glass, tempered glass, laminated glass, single pane glass, double pane glass, etc. and is not limited to any particular types of glass.

The sprayable glass composition of preferred embodiment are preferably sprayed on to glass to stabilize a window, door, curtain, or partition structures formed from or including glass or glass panes (for example including a glass door or framed glass door) installed in fabrications or constructions, such as office buildings and residential homes and apartments. It may be applied to window, door, curtain, partition structures of any type including one or more glass panes disposed in an opening circumscribed by a window, door, curtain, and partition frame. The opening and frame may form or be disposed in exterior or interior walls or doors of the fabrication or construction or may be free-standing, such as where the fabrications or constructions are showers, telephone booths, glass cubicles, tanks, balustrades, curtain windows, glass bricks and the like.

It will be appreciated the window, door, curtain, partition structure may include one or more tracks receiving a peripheral edge of the one or more window, door, curtain, partition glass panes. The glass panes may be flat or planar or may have curved or other non-planar shapes or profiles. The window, door, curtain, partition frame may be constructed separately from the fabrication or construction as a frame member including one or more parts, or may be formed integrally, unitarily with the fabrication or construction. The window, door, curtain, partition structure may include one or more transoms &/or mullions dividing the opening into separate sections, each receiving a window, door, curtain, partition glass pane.

In the latter case, the mullions may include tracks receiving peripheral edges of the window, door, curtain, partition glass panes. The tracks can be made as separate pieces, or can be formed integrally with the window, door, curtain, partition frame, the fabrication or construction and/or the mullions. Representative window, door, curtain, partition structures include sash windows, casement windows, sliding windows, sliding glass doors, non-movable windows, fixed windows, movable windows, protruding windows, recessed windows and the like in fabrications or constructions of any type. Fabrications and constructions using glass panes to which the composition of the preferred embodiment may be applied include commercial, residential, governmental and recreational fabrications or constructions. The composition may also be sprayed onto broken or fractured automobile windows.

Ingredients of the composition of the preferred embodiment are referred to hereinafter by a commercially available product name, associated chemical number affiliated and/or manufacturer. The amounts of the constituent components of the composition such as polymers, surfactants, etc. expedient for use in carrying out preferred embodiments of the invention and are intended to be illustrative only and, except as specifically stated, are not intended to be limiting. That is, the expedient composition constituents are subject to change or cessation by their respective manufacturer/s, and they can be substituted by like constituents provided by other manufacturers or formed by any expedient means. Whilst this description may not include a formal nomenclature used to describe the final composition any reference to amounts means that the composition includes those materials in the stated amounts, or the active ingredients thereof as would be understood by a skilled addressee.

The composition according to the preferred embodiment is a liquid at room temperature and is sprayable onto a glass pane or remnants thereof The preferred embodiment is generally intended to be applied to stabilize window, door, curtain, partition structures having shattered, broken, cracked or missing glass panes and to safely remove the shattered, broken, cracked glass from window, door, curtain, partition structures. Further, the preferred embodiment is intended to stabilize a window, door, curtain, partition structure in which all or substantially all of the glass is missing therefrom, to safely removing glass shards from a track of a window, door, curtain, partition structure, and to safely removing a shattered, broken, cracked window, door, curtain, partition glass pane. Additionally, the composition of the preferred embodiment can be applied to a window, door, curtain, partition which assists in protecting in against those shattered, broken or cracked windows, door, curtain, partition due to storm or other conditions.

The glass stabilising composition of the preferred embodiment includes an acrylic polymer emulsion in the amount of 40%-65%, and most preferably in the amount of 45%-65%. Such an acrylic polymer emulsion is Elastene 2438 (or Rhoplex 2438C) manufactured by the Dow Chemical Company and is most preferably added in the amount of 52.4% to 67.1% Elastene. The particulars of this product can be found at http://www.dow.com/products/search/Exterior/#/product-line/elastene/product/elastene-2468m-acrylic-emulsion/?&suid=137421498507809420851065056923.

The composition includes an acrylic binder in the amount of 16.8%-31.4%, most preferably in the amount of 18.8%-30.2%. The binder is in the form of an acrylic polymer and most preferably is Primal AC-3001 (or Rhoplex AC-3001) thermoplastic all-acrylic binder manufactured by the Dow Chemical Company. In other preferred embodiments the binder is preferably added in the amount of 23.5% to 31.8% AC-3001. The particulars of Primal AC-3001 can be found at http://www.dow.com/products/search/Exterior/#/product-line/rhoplex-ac/product/rhoplex-ac-3001/?&_suid=137421533129309806892547977568.

The composition of the preferred embodiment further includes an acrylic polymer emulsion thickener in the amount of 0.32%-0.62%, most preferably in the amount of 0.36%-0.58%. The acrylic polymer emulsion thickener is a rheology modifier in the form of a hydrophobically modified anionic thickener, preferably Acrysol TT615 manufactured by the Dow Chemical Company and is most preferably added in the amount of 0.4%-0.65% Acrysol. Particulars of the Acrysol TT615 can be found at http://www.dow.com/products/search/Exterior/#/products/market/construction/product-line/acrysol-rheology-modifiers/product/acrysol-tt-615/?&suid=13742156446050021333822834080307.

Additionally, an ester surfactant is included. This is present in the amount of 0.32%-0.62% and most preferably 0.36%-0.58%. The ester surfactant is most preferably a phosphate ester, for example, including triaryl, trialkyl, and aryl alkyl phosphates. In the preferred embodiment, the phosphate ester is STRODEX TH-100 manufactured by Ashland, Inc and is most preferably added in the amount of 0.45% to 0.61% STRODEX. Details of STRODEX can be found at http://www.ashland.com/Ashland/Static/Documents/AAFI/From%20East%20Database/Coatings%20Additives%20Literature/PC-10386_P&C_selectionguide.pdf.

To assist in the composition application once on a glass surface, the composition also includes a film control agent in the amount of 0.36%-0.58%. The foam control agent is oil based, most preferably polysiloxane based. In the preferred embodiment, the foam control agent is DREWPLUS T4507 manufactured by Ashland, Inc, and is most preferably added in the amount of 0.45% to 0.61% DREWPLUS. Details of DREWPLUS are available at http://www.ashland.com/Ashland/Static/Documents/AAFI/From%20East%20Database/Coatings%20Additives%20Literature/PC-10389_PSA_graphics.pdf.

The composition also includes water in the amount of 7%-12% and most preferably in the amount of 7.5%-10.2%. That is, the remainder of the composition is preferably water. However, it will be appreciated the water can be replaced with an alcohol or alcohol/water mixture. The alcohol is preferably an ethyl, methyl, propyl or butyl-alcohol but is not limited thereto.

The composition of the preferred embodiment is a liquid that is able to be sprayed. As such, a method of stabilising glass by spray applying the composition and forming a film coating thereon is also provided. The method includes the step of spraying the liquid composition as a liquid in small or atomised or aerosolised droplets on to one or both faces of the glass pane. The sprayed composition is then allowed to cure over a predetermined time. In practice, this is a relatively short period. This occurs by reaction of the composition with moisture therein and in the atmosphere and the sprayed composition forms a film adhered to the glass.

The composition of the preferred embodiment is easy to apply and is consumer friendly and not time consuming to apply. Moreover, there is an increasing interest to develop an easy to apply composition that is stable and suitable to be delivered in a desirable spray pattern in order to provide results that are beneficial to the user. The protective film spray composition of the preferred embodiment includes a substantially all liquid emulsification system that has an HLB from about 3.0 to 7.0 (wherein HLB is commonly understood to mean Hydrophile-Lipophile balance of a surfacant). The protective film spray composition is surprisingly stable, notwithstanding the low HLB emulsification system employed, and capable of being applied homogeneously to glass. Moreover, the system and method for delivering the spray protective film composition yields a desirable and continuous spray pattern in the absence of sputtering as well as a composition suitable to be quickly dried on the glass.

As noted, the sprayable composition according to preferred embodiments of the invention include a liquid carrier as a primary solvent.

The carrier fluid may be water, alcohol, or mixtures thereof While many thickening agents are known for increasing fluid viscosity such as that noted above, the preferred polyacrylic acid polymers exhibit a surprising and unexpected tendency to allow free flow under pressure for good sprayability of the sprayable composition, yet to prevent downward flow due to gravity once the sprayable protective film composition is in place on a surface to be protected.

A high yield value indicates that minimum shear stress is required to initiate flow will be greater than that effected by the force of gravity, thus allowing the sprayable protective film composition to non-runningly cling to (ie, dwell on) the surface onto which it has been sprayed, rather than running downwardly or dripping. In addition, there will be significantly reduced risk of damaging or discoloring window frames, adjacent walls or surfaces, furniture, plants, or other items which may be disposed below the surface sprayed with the protective film and which may otherwise be in contact with the protective film in contrast to present and prior protective methods used.

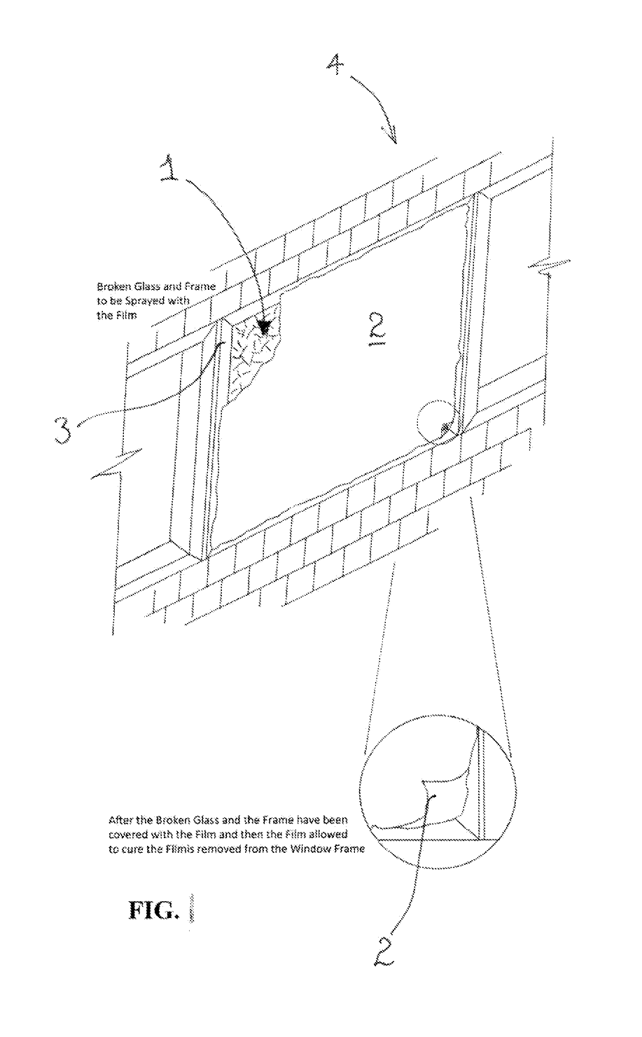

FIG. 1 is a schematic representation of the glass pane (1) having been sprayed with the sprayable glass stabilising composition according to a preferred embodiment. The composition is allowed to dry and the exploded view in FIG. 1 shows the cured film (2) as being able to be peeled away from or removed from the glass frame (3). The top left portion of the glass pane (1) in FIG. 1 is shown cracked or shattered and this would have the film (2) applied thereto, however, that portion of FIG. 1 is intended to show the cracked glass pane (1).

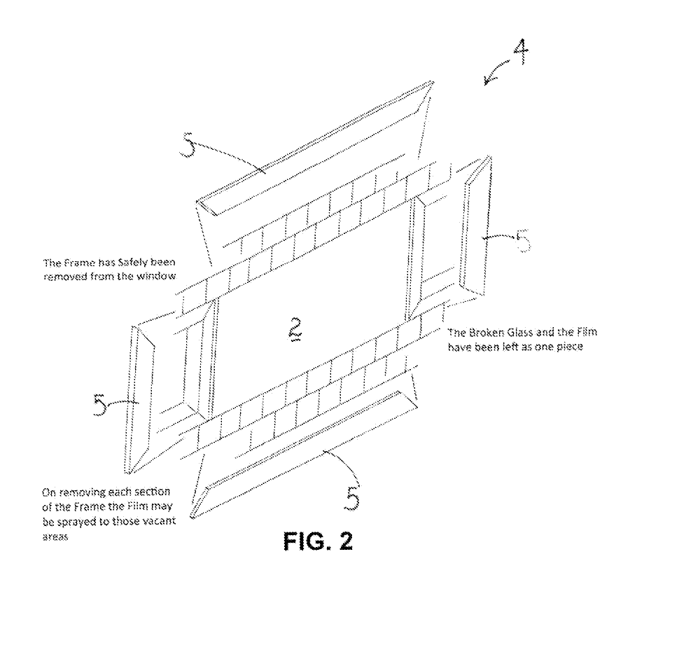

In FIG. 2, the window (4) of the preferred embodiments includes a surrounding frame formed from discrete frame members 5. Once the composition has cured to a film (2), each of the frame member (5) is able to be removed individually. Advantageously, as each frame member (5) is removed, the composition can be sprayed onto the area about the removed frame member (5). In this way, any remnants or fragments from glass pane (1) can be entrained with the composition as it cures and forms a film. It can be seen that the glass pain (1) having film (2) remains intact.

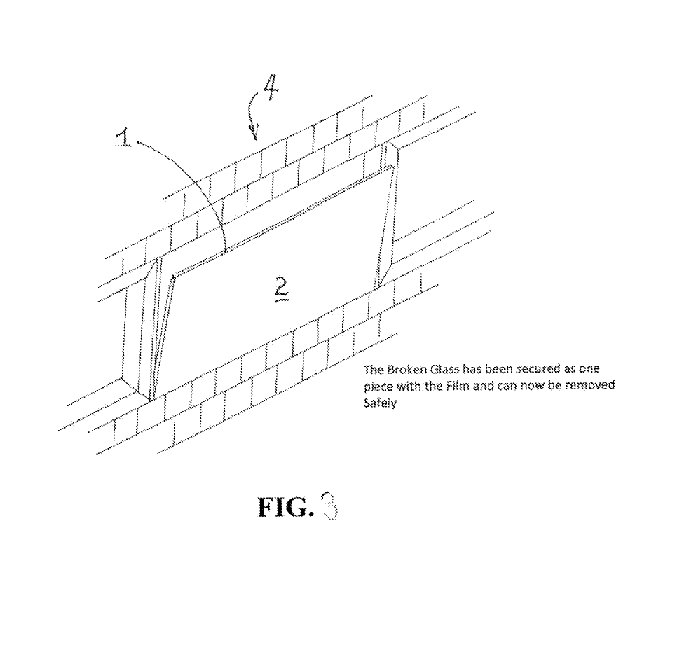

FIG. 3 shows the glass pane (1) being removed as one piece with the cured film (2) providing structural strength to prevent the glass pane (1) crumbling or separating. The removed pane (1) can be discarded as one piece with the cured film (2) left in place or the film (2) can be removed or partially removed as desired.

As the film (2) is cured, a predetermined force is applied to the glass pane (1) over which the composition has formed the film (2). This removes the fractured or broken glass pane (1) remnants attached to the cured composition film (2). The cured film (2) retains the glass pane (1) and remnants. Most advantageously and hitherto unknown, any of the composition sprayed other than on glass can simply be peeled off once cured without any damage to the frame (3) or surrounds to which the composition was applied, for example, to painted or aluminium surrounds. Thus, no masking, especially precise masking on any surrounding surfaces is required as the cured film (2) does not damage surrounding surfaces.

A systems and apparatus for applying or spraying the composition of the preferred embodiment to stabilise a glass pane (1) or remnants thereof is also contemplated. In particular, the system includes a container. In one embodiment, the container (40) is adapted to hold a pressurised predetermined volume of the composition. In another embodiment, the container (40) is configured to hold a predetermined volume of the composition whereby the container (40) is adapted to be pressurised by a pressurising fluid, namely either charged or where an external compression source such as an air compressor or hand pump is used. It will be appreciated that any preferred pressuring fluid can be used as desired, however, air, nitrogen or a hydrocarbon propellant are preferred.

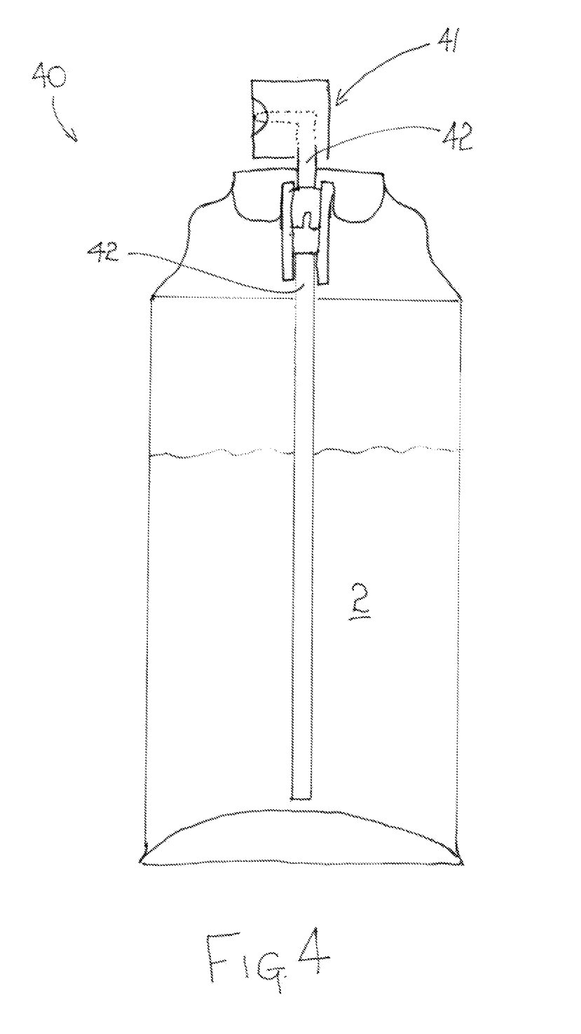

The first preferred embodiment of a dispenser is shown in FIG. 4 and contemplates application via an aerosol can arrangement with the container (40) holding the composition 2 in liquid form. The liquid composition (2) pressurised by a propellant being a hydrocarbon or a combination of hydrocarbons thereof. For example, a mixture of butane and propane propellant, or dimethyl ether, amongst many others.

In the system, an actuator (41) is provided to allow the selective release of the composition under pressure for application directly from the container (40) onto the pain (1). The actuator (41) is connected to an outlet (42) of the container (40) and configured to be operated to selectively release the composition under pressure. In this embodiment, only an outlet (42) is provided making the container (40) disposable.

A second preferred embodiment of an applicator for the composition (2) is shown in FIG. 4. This is based on a conventional air-compressor poured spray gun (50). The gun (50) includes an inlet (51) to receive the liquid composition (2) from a re-Tillable container (52). Within the gun (50), the composition inlet (51) is in fluid composition with compressed air inlet (53). The compressed air is is provided by a conventional air composition (not illustrated), connected by hose (54).

An actuator (41) or trigger (55) allows releases of compression air from nozzle (56) of the gun (50). The flow of compressed air through the gun (50) draws the liquid composition (2) and entrains this into the airstream as atomised droplets. The droplets are dispensed on (or around) pane (1) and left to cure to form film (2).

It will be appreciated that the composition does not need to be applied with a uniform thickness to the pane (1). It only needs to be applied so as to cover or substantially cover the pain (1) to allow the film to form thereon. In a particularly preferred embodiment, the composition according to the preferred embodiment can be placed into a manual pump spray applicator such as Model SSA manufactured by Calmar, Inc. having an orifice size of 0.025 inches in diameter. Here, the sprayable composition was found to be equally effective when sprayed onto the surface using this manual pump spray applicator. The sprayable composition according to a preferred embodiment was found to be sprayable and to have a surprising tendency to non-runningly cling to and to dwell on surfaces disposed at any orientation when sprayed thereon, yet the sprayable protective film composition provided excellent surface protection while being easily spread onto any glass surface.

It will be appreciated that the system above is the first known to dispense a one-part composition for stabilising glass panes. Of course as the composition cures and the film (2) forms, it adds relatively insignificant weight on application and once cured.

Also, it will be appreciated that in an exemplary embodiment there is provided an emergency clear glass film (2) in a spray can for the stabilizing a shattered, broken, cracked glass in a window, door, curtain, partition structure having a window, door, curtain, partition frame (3) entirely or substantially entirely devoid of glass to cover the opening in its entirety. A body of unifying clear film (2) is sprayed over and bonded to the glass to form a cohesive mass therewith. This is especially advantageous in a home environment since a can is relatively small and requires no special skill to apply.

Some of the advantages of the present invention are that the risks of injury and/or damage presented by window, door, curtain, partition structures having shattered, broken, cracked window, door, curtain, partition glass panes or window, door, curtain, partition glass panes that are:
(i) entirely or substantially entirely missing or greatly reduced; shattered, broken, cracked glass panes of window, door, curtain, partition structures can safely remain in place for some time prior to removal;
(ii) window, door, curtain, partition structures in which all or substantially all of the glass is missing can be stabilized prior to and while awaiting installation of replacement glass;
(iii) the barrier or seal that is compromised in window, door, curtain, partition structures having damaged or missing glass can be substantially or fully restored while allowing the damaged glass to be left in place with the film (2) thereon;

1(iv) window, door, curtain, partition structures can be stabilized and/or damaged glass removed therefrom in substantially less time and with substantially less labour than are required for other stabilizing and removal procedures;
(v) the cohesive or unifying material is easy to apply with only negligible pressure or force being exerted on the glass; formation of one or more cohesive or unified masses may be achieved in only a short time after the unifying spray film (2) is applied;
(vi) a shattered, broken, cracked pane can be stabilized and removed quickly in one procedure, if desired; window, door, curtain, partition glass pane shards can be removed quickly in one procedure;
(vii) the unifying spray film (2) may be used for stabilization and/or removal of shattered, broken, cracked glass panes in emergency situations, particularly windows, doors, curtains, partitions can be stabilized quickly following catastrophic events, such as earthquakes, explosions, and the like, which may result in massive glass window, door, curtain, or partition damage;
(ix) intact glass windows, doors, curtains, partitions can be structurally reinforced by the spray film (2) material quickly prior to predictable catastrophic events as well as during the occurrence of certain catastrophic events; the weight of the unifying spray film (2) on the glass is insubstantial;
(x) the composition/compositions for the unifying spray film (2) material can be stored in small containers prior to use; the composition/compositions may be provided with a shelf life, where conditions of stored would apply;
(xi) the unifying spray film (2) material can be applied by one person; the unifying spray film (2) material may be translucent so that light may pass there through;
(xii) the unifying spray film (2) material may be applied to the exterior side and/or the interior side of a glass window, door, curtain, partition structure;
(xiii) enhanced stabilization and protection may be achieved by applying the unifying spray film (2) material to both the exterior and interior sides;
(xiv) the unifying spray film (2) material will not lose its shape or protective qualities when exposed to environmental elements such as rain;
(xv) the composition of the preferred embodiment fulfils unmet needs of emergency responders and do-it-yourself repairers as well as glass professionals;
(x) the methods of stabilizing and/or removing may be self-customized to optimize use in diverse situations; and
(xi) the ability to use a variety of different types of applications.

The aforementioned preferred embodiments of the present invention advantageously provide sprayable protective compositions suitable for the temporary protection of glass surfaces such as exterior windows and doors, or interior windows and door glass surfaces through the deposition on the surface of the protective film 2. The film 2 can subsequently be readily removed therefrom when required by a simple peeling operation.

So far as there exists a need for a product that can provide a temporary protection for exterior and interior glass surfaces against weather conditions, contamination from the atmosphere, or accidental damage the composition of the preferred embodiments satisfies this. The present composition provides such protection by applying to the existing glass surfaces a sprayable protective film which can easily be removed later without deleterious effect upon the glass surfaces in question.

Such protection is particularly desirable in the commercial building industry, where a completed or partially completed commercial building may have broken or fractured glass surfaces which necessitates the building or the surrounding commercial area being closed until such broken or fractured glass surfaces are repaired. For example, where a newly completed building may have a commonly used expedient to coat the newly built structure with a weatherproofing and to some extent damage-resistant laminated shield or protective glass surface that prevents broken or fractured pieces of glass falling from the building to protect the building structure and surrounding area from damage, this is not true for most older buildings. These structures have not been fitted with such features as they are hitherto unknown. These types of buildings account for the majority of structures in commercial areas. Thus the need for a temporary protection for exterior and interior glass surfaces is evident and the sprayable protective film composition 2 of the preferred embodiments is suitable for such temporary protection and which can subsequently be easily removed.

It will be appreciated that the protective film composition may be applied to glass structures by any conventional method of spraying, (including aerosol or manual spraying). The applied material is then allowed to dry, either spontaneously at room temperature or under moderately forcing conditions in a current of warm air. Coalescence and the development of a satisfactory water-resistant film are found to occur more rapidly with the compositions of the invention than with the prior art compositions based on foam applications. This advantage is of particular significance when the compositions are used for temporary protection of glass surfaces that are out of doors and are liable to be subjected to various weather conditions very shortly after application.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A sprayable glass stabilising composition comprising:
an acrylic polymer emulsion in the amount of 40%-65%;
an acrylic binder in the amount of 16.8%-31.4%;
an acrylic polymer emulsion thickener in the amount of 0.32%-0.62%;
an ester surfactant in the amount of 0.32%-0.62%;
a foam control agent in the amount of 0.32%-0.62%; and
water or alcohol, or a mixture thereof, in the amount of 7%-15%.

2. A composition according to claim 1 comprising:
the acrylic polymer emulsion in the amount of 45%-65%;
the acrylic binder in the amount of 18.8%-30.2%;
the acrylic polymer emulsion thickener in the amount of 0.35%-0.58%;
the ester surfactant in the amount of 0.35%-0.58%;
the foam control agent in the amount of 0.35%-0.58%; and
water or alcohol, or a mixture thereof, in the amount of 7.5%-13%.

3. A composition according to claim 1 wherein the acrylic polymer emulsion is Elastene 2438 manufactured by the Dow Chemical Company.

4. A composition according to claim 1 wherein the acrylic binder is an acrylic polymer.

5. A composition according to claim 1 wherein the acrylic polymer emulsion thickener is a rheology modifier in the form of a hydrophobically modified anionic thickener, preferably Acrysol TT615 manufactured by the Dow Chemical Company.

6. A composition according to claim 5 wherein the acrylic binder is Primal AC-3001 manufactured by the Dow Chemical Company.

7. A composition according to claim 1 wherein the ester surfactant is a phosphate ester.

8. A composition according to claim 7 wherein the phosphate ester is selected from the group consisting of: triaryl, trialkyl, and aryl alkyl phosphates.

9. A composition according to claim 7 wherein the phosphate ester is STRODEX TH-100 manufactured by Ashland, Inc.

10. A composition according to claim 1 wherein the foam control agent is oil based.

11. A composition according to claim 10 wherein the foam control agent is polysiloxane based.

12. A composition according to claim 11 wherein the foam control agent is DREWPLUS T4507 manufactured by Ashland, Inc.

13. A sprayable glass stabilising composition comprising:
an acrylic polymer emulsion of Elastene 2438 manufactured by the Dow Chemical Company in the amount of 52.6%-67.1%;
an acrylic binder of Primal AC-3001 manufactured by the Dow Chemical Company in the amount of 23.5%-31.8%;
an acrylic polymer emulsion thickener of Acrysol TT615 manufactured by the Dow Chemical Company in the amount of 0.45%-0.61%;
an ester surfactant of STRODEX TH-100 manufactured by Ashland, Inc in the amount of 0.45%-0.61%;
a foam control agent of DREWPLUS T4507 manufactured by Ashland, Inc in the amount of 0.45%-0.61%; and
water or alcohol, or a mixture thereof, in the amount of 7.5%-10.2%.

14. A method of stabilising a glass pane, the method comprising the step of spraying the composition according to claim 1 as liquid or aerosolised liquid on to one or both faces of the glass pane and allowing same to cure and form a film on said glass.

15. A method of removing a fractured or broken glass pane from a frame or retaining fitting, the method comprising the steps of:
spraying the composition according to claim 1 as a liquid or aerosolised liquid onto at least one face of the remnants of the fractured or broken glass pane;
waiting a predetermined period of time for the sprayed composition to cure and form a film on said glass;
applying a predetermined force to the glass pane and removing the fractured or broken glass pane remnants attached to said cured composition; and
peeling any cured composition from about the pane frame.

16. A sprayable glass stabilising composition applicator system comprising:
a container adapted to hold a pressurised predetermined volume of the composition according to claim 1 such that the container is adapted to be pressurised by a pressurising fluid; and
an actuator connected to an outlet of the container and configured to be operated to selectively release the composition under pressure.
